(19) United States
(12) Patent Application Publication
(10) Pub. No.: US 2012/0297529 A1
(43) Pub. Date: Nov. 29, 2012

(54) HOME AND TRAVEL BIDET

(75) Inventor: Vaughn F. Bowcutt, Washington, UT (US)

(73) Assignee: KYDEN MACHINE INC., Washington, UT (US)

(21) Appl. No.: 13/117,748

(22) Filed: May 27, 2011

(51) Int. Cl. A61H 35/00

(52) U.S. Cl. 4/448

(57) ABSTRACT

A personal, portable sanitary device and system is disclosed. The device and system may include various components, such as a portable container for housing fluid, an attachment body with a lumen formed through the attachment body to allow for fluid flow, a fastening system to attach the attachment member to the portable container, a wand comprising a lumen to allow for fluid flow and an outlet to allow fluid to exit the wand, a connecting member for connecting the attachment body to the wand, and a member used to seal an opening in the portable container.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

The disclosure relates generally to sanitary and hygienic devices, systems and related methods of use, and more particularly, but not necessarily entirely, to a portable sanitary and hygienic devices, systems, and related methods of use for supplying a source of fluid for purposes of washing or cleaning a user's body and body cavities.

Sanitary washing devices and systems may include a stand-alone bidet having a porcelain tank and a faucet where water is presented for a user to wash or clean the user's body, including body cavities. Typical stand-alone bidets are fixtures in a bathroom and may be located next to a toilet and may be secured to a floor in a similar manner.

Other sanitary washing devices and systems may include bidet attachments that may be affixed to an existing toilet. Such bidet attachments may generally comprise a pressurized water source, tubing for water conveyance and a wand having an outlet or spray nozzle for the water stream to exit. Such bidet attachments are not easily transported or removed from the toilet. Further, such bidet attachments may require the user to position himself or herself over the spray nozzle in a manner to take advantage of the water to clean the user's body and body cavities. Such movement can be very difficult and/or uncomfortable for individuals who have difficulty in moving due to various conditions or for those whose mobility has been limited due to age, arthritis, recent surgery, or obesity or are otherwise disabled. Some bidets include a hand-held wand that allows a user to more accurately position the spray nozzle into the desired position. However, this type of wand has proven to be most inefficient as they are much too short in length. It is to be noted the length of the wand should be considered since a wand of proper length provides increased accuracy and allows a user to easily grasp the wand in a comfortable manner during use. With a properly sized wand, the users need not position their hands fully between their legs.

Generally, bidets use a spray nozzle to provide pressurized water to the user. In many cases, the pressurized water is much too forceful, resulting in splashing. Such nozzles can also be uncomfortable or even painful when used, due to the pressure. The pressurized stream of water can lead to significant discomfort when used by individuals having medical conditions such as hemorrhoids, sutures after surgery, or the like.

Furthermore, existing bidets are not easily transported and used either in other bathrooms or when traveling, because they are affixed to a bathroom's water source, e.g., a relatively constant water supply, and affixed to either the floor, in the case of a stand-alone bidet, or a toilet, in the case of a bidet attachment.

Despite the advantages of existing sanitary washing devices, systems, and related methods of use, improvements are still being sought. The existing sanitary washing devices, systems, and related methods of use may be characterized by several disadvantages that may be addressed by the disclosure. The disclosure minimizes, and in some aspects eliminates, the problems of existing sanitary washing devices, systems, and related methods of use, by utilizing the methods and structural features described herein.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is an exploded view of an embodiment of a personal, portable sanitary device and system made in accordance with the principles of the disclosure;

FIG. 1A is an exploded view of an embodiment of a personal, portable sanitary device and system made in accordance with the principles of the disclosure;

FIG. 2 is an illustration of an embodiment of a personal, portable sanitary device and system made in accordance with the principles of the disclosure, illustrating an embodiment of an attachment body installed onto a portable container;

FIG. 3 is an exploded view of an embodiment of a personal, portable sanitary device and system made in accordance with the principles of the disclosure; and

FIG. 4 is an illustration of an embodiment of a personal, portable sanitary device and system made in accordance with the principles of the disclosure installed onto a portable container.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the devices, systems, and methods for cleansing a user with a personal portable, sanitary bidet-type apparatus are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

It must be noted that, as used in this specification and the appended claims, the singular forms “a,” “an,” and “the” include plural referents unless the context clearly dictates otherwise.

In describing and claiming the subject matter of the disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

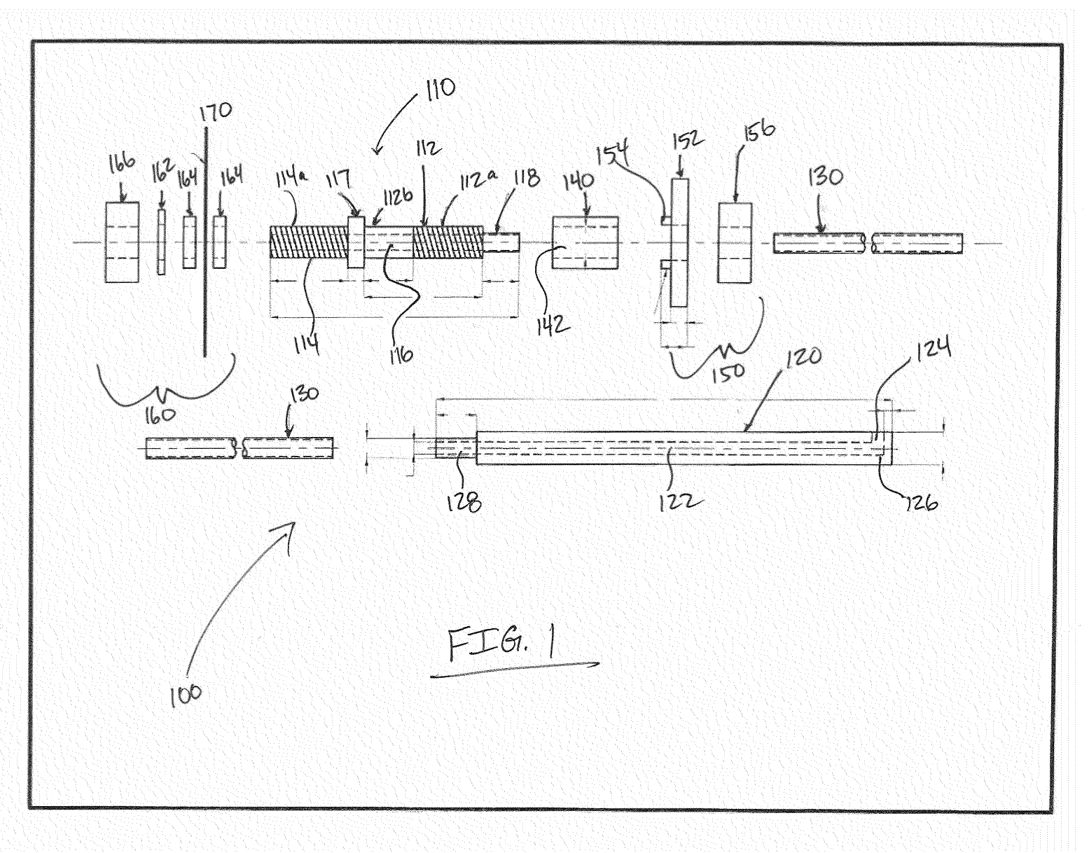

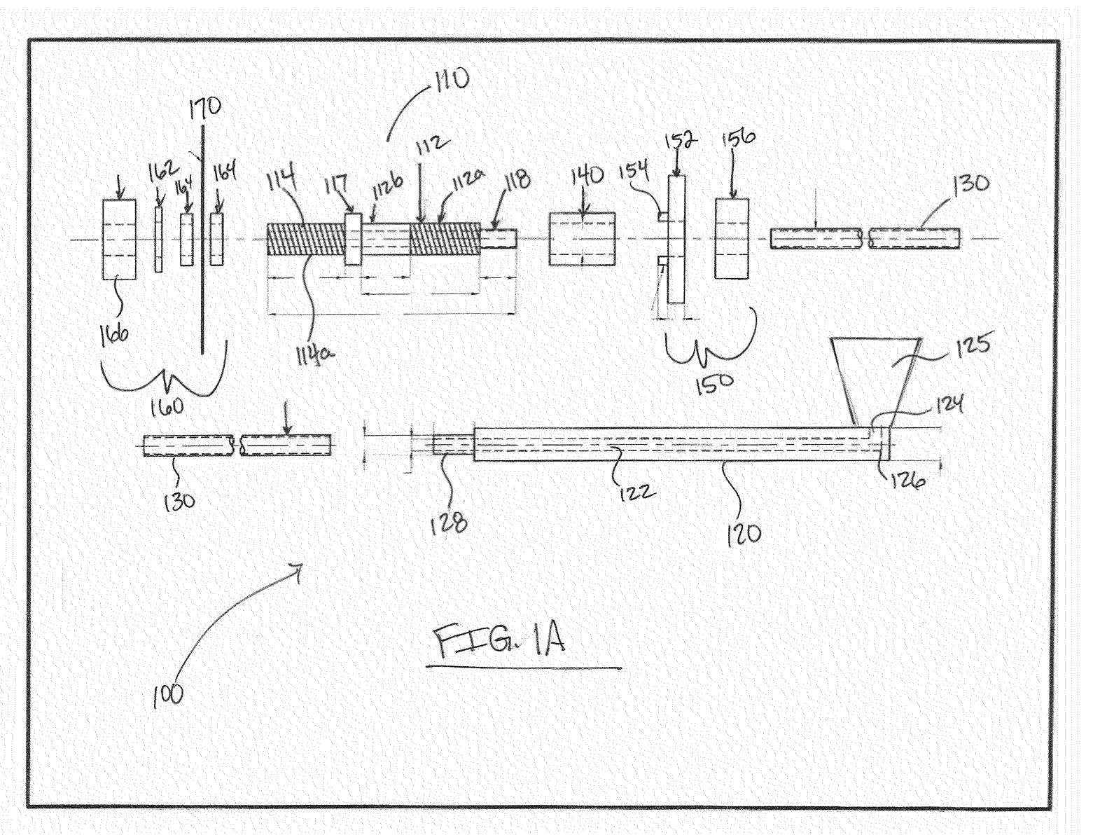

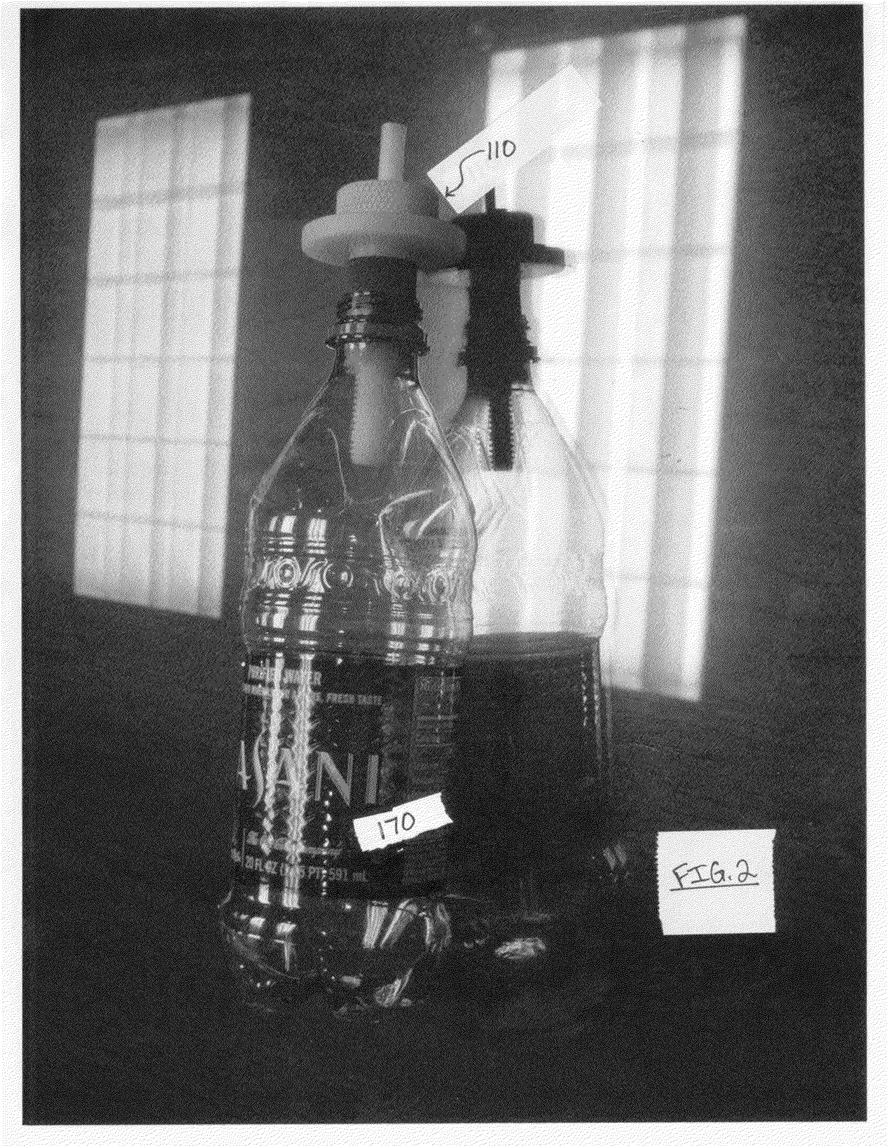

Referring now to FIGS. 1 and 2, an embodiment of a personal, portable sanitary device and system for cleansing a user is illustrated. An embodiment of a personal, portable sanitary device 100 may comprise an attachment body 110, a wand 120, a connecting member 130, a stopper 140, a first fastening assembly 150 and a second fastening assembly 160. The personal, portable sanitary device 100 may be used in combination with a portable container 170 for storing and supplying fluid, such as water or other fluid appropriate for use as a cleansing agent for a user, thereby creating a system.

Generally, the attachment body 110 may be used to connect or attach to a portable container 170. The stopper 140, first fastening assembly 150, and the second fastening assembly 160 may be used, either alone or in combination with other components of the device and system 100, to substantially seal an opening in the portable container 170. The connecting member 130 may be used to connect or attach the attachment member 110 to the wand 120, such that there is mechanical, fluid communication from the portable container 170 all the way through to the wand 120.

Referring to FIG. 1, an embodiment of the wand 120 is illustrated. The wand 120 may comprise a lumen 122 to allow for fluid flow therethrough. The wand 120 may also comprise an outlet 124 to allow fluid to exit the lumen 122 of the wand 120. It will be appreciated that a lumen may be a negative space defined by surrounding structure or wall of the wand. Thus, a lumen may be a canal, duct, passage, cavity, or other negative space of a structure, such as the wand 120. The lumen and structure of the wand may comprise a bend 126 that may be in communication with the outlet 124 to direct the flow of fluid when exiting from the wand 120 to a particular location that the user directs and controls. Additionally, the bend 126 formed in the wand 120 may also facilitate and create a turbulent flow of fluid, as opposed to laminar fluid flow, such that the fluid may be sprayed to a degree when exiting the outlet 124 to help facilitate cleansing a user and avoid an intense stream of fluid that could injure or otherwise hurt a user.

Referring now to FIG. 1A, in an embodiment of the disclosure the wand 120 may comprise an attachment head 125 that may be removably attached to the wand 120, which may include interchangeable attachments or an attachment with a plurality of various spray types, such as oscillation or other sprayer variation. The attachment head 125 may be connected or attached to the outlet 124 of the wand 120. With the attachment head 125 connected or attached to the outlet 124, the wand 120 possesses an “L” configuration. Such a configuration may allow for ease of cleansing a user's body and directional spray ability. In another embodiment, a hook or other clasping assembly may be implemented onto the end of the wand 120 near the outlet 124 to hang, store or otherwise hold the device and system 100 in a bathroom, for example on or near a toilet, for ease of use.

To assist the user who may have limited mobility in directing the location of the pressurized fluid, the wand 120 may comprise a length or plurality of lengths. The length “L” of the wand 120 is limited only by functionality, but generally may be within a range of about six inches to about ten inches, such that the wand 120 is sufficiently long to locate the outlet 124 of the wand 120 with respect to a user and thereby direct the flow of fluid to the user's body and body cavities with limited body movement from the user.

The wand 120 may comprise a mechanism for attaching the connecting member 130 to the wand 120. One mechanism to accomplish that function includes a coupler 128 located at an end of the wand 120. The coupler 128 may be located on an end that is opposite the outlet 124 of the wand 120. The coupler 128 may be sized, shaped, configured, and dimensioned to couple the connecting member 130 to the wand 120. The diameter, size, and cross-sectional shape of the coupler 128 may correspond with the diameter, size, and cross-sectional shape of the connecting member 130.

Still referring to FIG. 1, an embodiment of the connecting member 130 is illustrated. The connecting member 130 may function to attach or connect the attachment body 110 to the wand 120. The connecting member 130 may comprise a lumen to allow for fluid flow. In an embodiment, the connecting member 130 may be a flexible tubing that is attachable to the coupler 128 of the wand 120 via an interference fit. It will be appreciated that the length of the connecting member 130 may be of any suitable length to allow a user to maneuver and locate the wand 120 into a position suitable for its use and intended purpose, which may be to provide a stream or spray of fluid from a portable container. The connecting member 130 may be any structural component that comprises a lumen for fluid flow and that may be flexible enough to maneuver and position the wand in a number of different orientations.

Continuing to refer to FIG. 1, an embodiment of the device or system 100 may include the stopper 140. The stopper 140 may be used to substantially seal the opening into the portable container 170, such that fluid leakage may be minimized or completely eliminated. The stopper 140 may be manufactured from any suitable material that is compressible, for example soft rubber. The stopper 140 may be compressible such that it may expand within a range. Thus, the stopper 140 may seal a plurality of opening sizes of the portable container 170 within a corresponding range. The stopper 140 may radially expand when the stopper 140 is compressed. For instance, as the first fastening assembly 150 is compressed with respect to a substantially stationary flange 117 on the attachment body 110, or with respect to the second fastening assembly 160, a seal may be created with respect to an entry or opening into the portable container 170, which may be configured and arranged for storing fluid.

As illustrated in FIG. 1, an embodiment of the attachment body 110 may comprise a first attachment site 112, a second attachment site 114, and a lumen 116 formed through the attachment body 112 to allow for fluid to flow therethrough. It will be appreciated that the dual attachment sites 112, 114 permit the attachment body 110 to be used in combination with multiple portable containers (illustrated best in FIG. 2) to attach. For instance, the portable container, such as a bottle, plastic bag or other container, may comprise an opening to which the attachment body 110 may be connected. It will be appreciated that the first attachment site 112 may be used to attach or connect the attachment body 110 to the container and to seal the opening of the container 170. Openings of containers maybe within a range of about 0.75 inches to about 1.25 inches in diameter, such that the attachment body 110 and its component parts, including the stopper 140, may be configured and dimensioned to seal such openings. Thus, it will appreciated that the stopper 140 may be compressed to seal openings within the above noted range.

The attachment body 110 may further comprise a coupler 118 at an end of the attachment body 110. The coupler 118 may be configured and dimensioned to couple or otherwise attach the connecting member 130 to the attachment body 110. The coupler 128 may be sized, shaped, configured, and dimensioned to couple the connecting member 130 to the wand 120. The diameter, size, and cross-sectional shape of the coupler 118 may correspond with the diameter, size, and cross-sectional shape of the connecting member 130. In an embodiment, the connecting member 130 may be a flexible tubing that is attachable to the coupler 118 of the attachment body 110 via an interference fit. It will be appreciated that the connecting member 130 may be manufactured from any suitable material that is flexible and can structurally accommodate a tube or channel, including nylon or TYGON® tubing. The attachment body 110 may be manufactured from any suitable material, including nylon, teflon, aluminum, stainless steel, and any polymeric material that is suitable for use as a structural member.

As part of connecting the attachment body 110 to the portable container 170, the personal, portable sanitary device and system 100 may include the first fastening assembly 150 and the second fastening assembly 160, which may be used to connect to the first attachment site 112 and the second attachment site 114, respectively. The first attachment site 112 of the attachment body 110 may comprise a first threaded section 112a and a first unthreaded section 112b. The second attachment site 114 may comprise a second threaded section 114a. It will be appreciated that the first attachment site 112 may be separated from the second attachment site 114 by a substantially stationary flange 117, such as a flange, nut, or other structural member to provide a substantially stationary support.

The first fastening assembly 150 may comprise an expansion gasket 152 having a lip 154 extending from a the main portion of the gasket 152. The lip 154 may engage or abut the stopper 140 during use. The expansion gasket 152 may be used in conjunction with the stopper 140 to assist the stopper 140 in sealing the opening to the portable container 170. The expansion gasket 152 may be manufactured from any suitable material, including nylon, and may comprise a knurl for gripping purposes. The stopper 140 may comprise a channel 142 having a diameter that may be configured and dimensioned to correspond with the diameter of the first attachment site 112 to allow the first attachment site 112 to enter through the channel 142 of the stopper 140. The first fastening assembly 150 may further comprise a threaded nut 156 for matingly engaging the first threaded section 112a of the first attachment site 112. The threaded nut 156 may be manufactured from any suitable material, including nylon, and may comprise a knurl on the exterior surface for ease in gripping the nut 156.

The second fastening assembly 160 may comprise at least one nylon or teflon washer 162, a gasket 164 of any compliant, flexible material, and a threaded nut 166 for matingly engaging the threaded section 114a of the second attachment site 114. The threaded nut 166 may be manufactured from any suitable material, including nylon, and may comprise a knurl on the exterior surface for ease in gripping the nut 166. The at least one washer 162 may be manufactured from any suitable material, but functions best when it is made of a hard material such as nylon or teflon such that the nut 166 will slide against the washer 162 when the nut it tightened on the threaded section 114a without crimping or otherwise deforming the gasket 164. Deforming the gasket 164 during tightening of the nut 166 may cause the seal to leak.

It will be appreciated that the attachment body 110 may comprise two different sealing sites and attachment mechanisms for sealing different types of portable containers 170 comprising fluid. The first sealing site may be a hard compression seal created by compression of the stopper 140 within or at the opening of the portable container 170 by the first fastening assembly 150. The second attachment site may be a soft compression seal created by compression of a flexible, compliant material of the gasket 164 by the threaded nut 166 and washer 162 of the second fastening assembly 160.

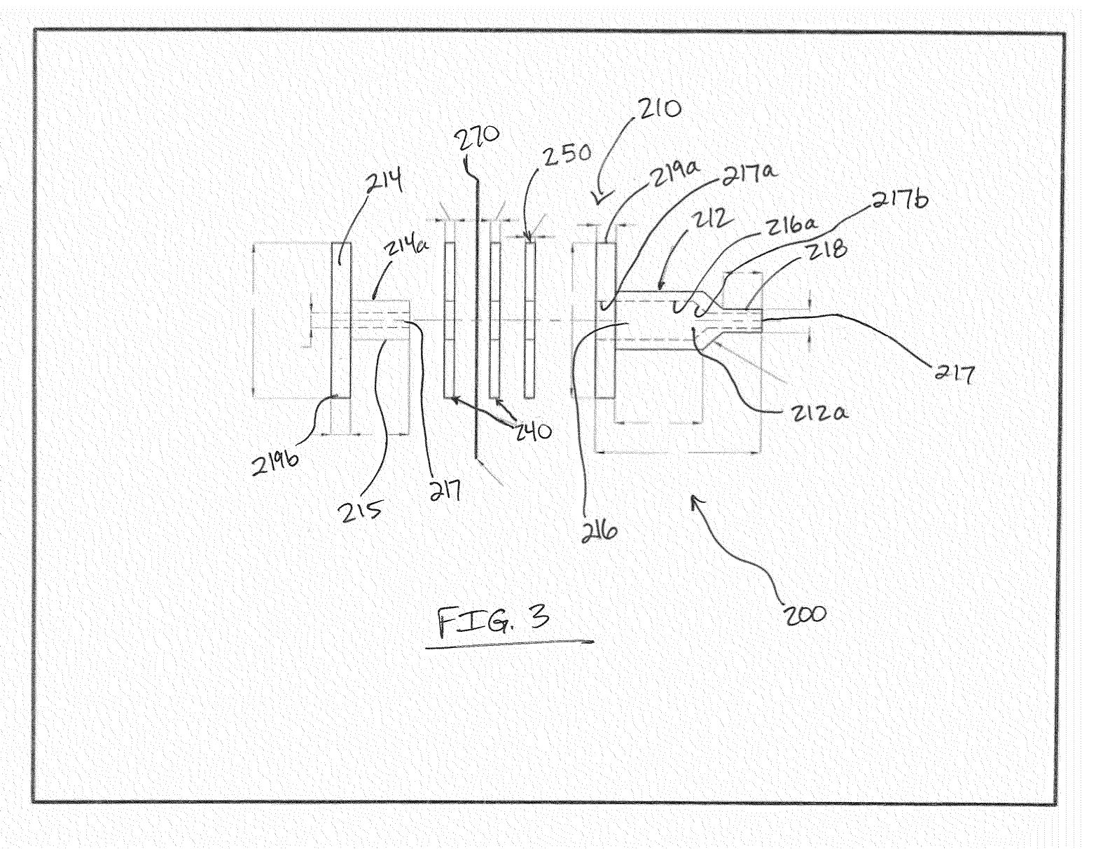

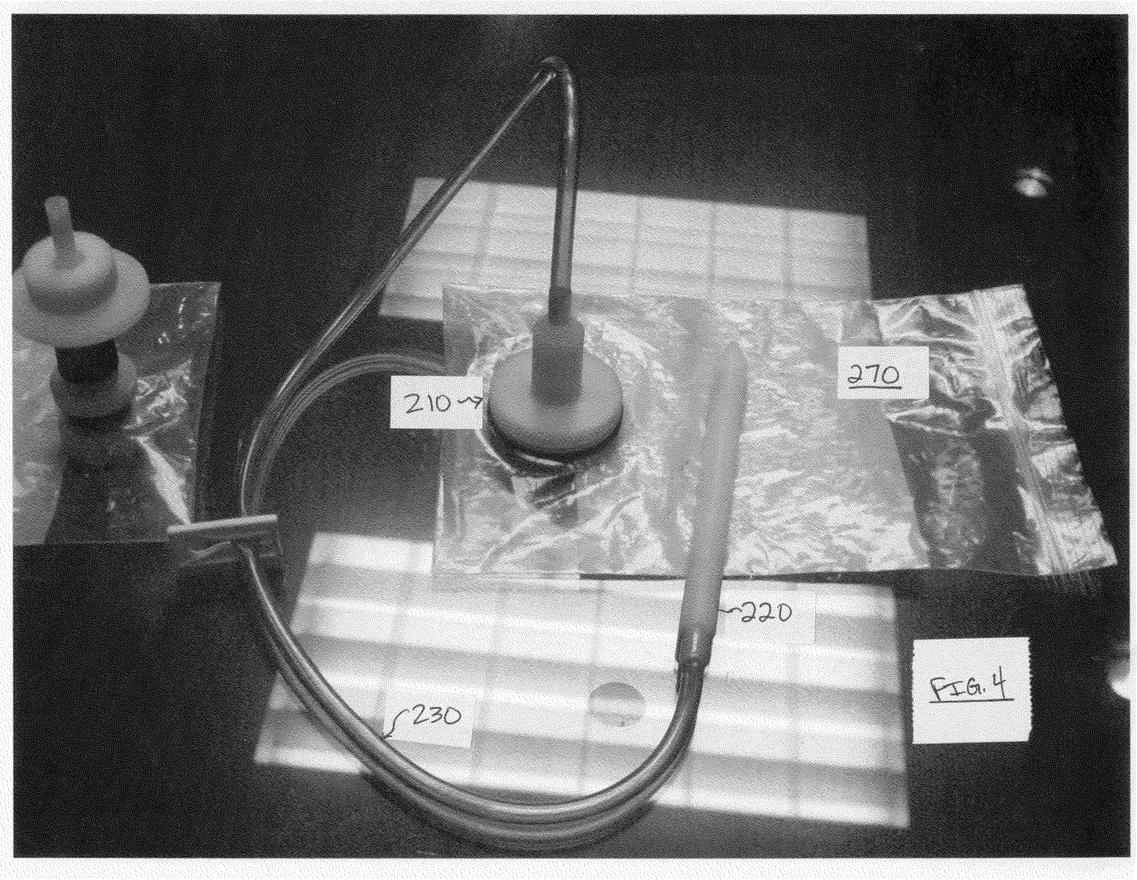

Referring now to FIGS. 3 and 4, another embodiment of a personal, portable sanitary device and system 200 is illustrated. The system may comprise a portable container 270 for housing fluid, an attachment body 210 with a first modular portion 212 and a second modular portion 214, a wand 220, a connecting member 230, a plurality of gaskets 240, and a washer 250.

The portable container 270 may comprise an opening therein to permit fluid to flow out of the portable container and into the connecting member 230. The portable container 270 may be a flexible bag that is configured to hold fluid without substantial leakage. For example, the flexible bag may be a sealable plastic bag or any other flexible, material that can be sealed to contain fluids therein. The opening to the portable container 270 may be pre-formed and may be sealed by the attachment body 210.

The attachment body 210 may comprise the first modular portion 212, the second modular portion 214, and a lumen 217 formed through each component of the attachment body 210. It will be appreciated that when the first modular portion 212 and the second modular portion 214 of the attachment body 210 are assembled together, each lumen 217 of those components may be substantially aligned to allow for fluid flow through the entire attachment body 210. The attachment body 210 may also comprise a coupler 218 at an end of the attachment body 210 that may be configured and dimensioned to couple the connecting member 230 to the attachment body 210.

The first modular portion 212 of the attachment body 210 may comprise a first attachment site 212a and may further comprise a male connector 215 or a female connector 216. The second modular portion 214 may comprise a second attachment site 214a and may further comprise the corresponding, opposite male connector 215 or female connector 216 with respect to the first modular portion 212. No matter the configuration or location of the male and female connectors 215, 216 with respect to the first modular portion 212 and second modular portion 214, the male connector 215 may be insertable through the opening of the portable container 270 and into the female connector 216 of the attachment member 210 to form a friction fit, such that when the first modular portion 212 is assembled with the second modular portion 214 a compression force is applied to the gaskets 240 to substantially seal the opening of the portable container 270.

It will be appreciated that the female connector 216 may be a receptacle that connects to and holds the male connector 215. The receptacle or cavity of the female connector 216 may be defined by a sidewall 216a. In an embodiment, the sidewall 216a may be substantially cylindrical at one end 217a and tapering at the other end 217b to a shoulder of the receptacle or cavity. When the male connector 215 is inserted and assembled into the female connector 216, the lumen 217 of the attachment body 210 may be substantially aligned.

The first modular portion 212 may comprise a first lip or abutment 219a. In an embodiment, the lip or abutment 219a may engage one of the plurality of gaskets 240 on the outside of the portable container 270. The second modular portion 214 may comprise a second lip or abutment 219b. In an embodiment, the second lip or abutment 219b may engage another one of the plurality of gaskets 240 on the inside of the portable container 270. In an embodiment, the male connector 215 may be insertable through one of the plurality of gaskets 240, through the opening of the portable container 270, through another one of the plurality of gaskets 240 and into the female connector 216, thereby creating a soft compression seal to substantially seal the opening of the portable container 270.

It will be appreciated that the male connector 215 may be configured and dimensioned with respect to the female connector 216, such that the male connector 215 does not bottom out in the receptacle or cavity of the female connector 216. Such an arrangement allows for the first lip or abutment 219a of the first modular portion 212 and the second lip or abutment 219b of the second modular portion 214 to substantially abut each other with the plurality of gaskets 240 located between them to create the soft compression seal.

As noted above, the plurality of gaskets 240 may be used for substantially sealing the opening in the portable container 270 along with the attachment body 210 when the male connector 215 is inserted into the female connector 216 to form a friction fit. The gaskets 240 may be made from a flexible, compressible material, such as rubber or any other compliant, flexible material. Washer 250 functions best when it is made of a hard material such as nylon or teflon that will slide against the female connector 216 when the male connector 215 is tightened against the female connector 216. During tightening the gaskets 240 should not be crimped or deformed, because crimping or deforming them can cause the seal to leak. The system 200 may further comprise the wand 220 and the connecting member 230. The wand 220 and the connecting member 230 may comprise the same structural and functional aspects as the wand 120 and the connecting member 130 described herein above. For the sake of clarity, the discussion related to those components above is hereby incorporated into the embodiment by this reference.

In accordance with the features and combinations described above, a useful method for cleansing a user with a personal, portable sanitary system may comprise:

providing a portable container for housing fluid, wherein the container comprises an opening;

inserting an attachment body into the opening of the portable container, wherein the attachment body comprises a first attachment site, a second attachment site, and a lumen formed through the attachment body to allow for fluid flow;

attaching a connecting member to the attachment body and to a wand, wherein the wand comprises a lumen to allow for fluid flow and an outlet to allow fluid to exit the wand and the connecting member comprises a lumen to allow for fluid flow, such that there is a continuous flow of fluid from the portable container through the lumen of the attachment body into the connecting member and into the wand to thereby expel and spray the fluid when a compression force is applied to the portable container.

Those having ordinary skill in the relevant art will appreciate the advantages provide by the features of the disclosure. For example, it is a feature of the disclosure to provide a personal, portable sanitary device and system for cleansing a user, which is simple in design and manufacture. Another feature of the disclosure is to provide a personal, portable sanitary device and system for cleansing a user that is compact and useable on the road or trip when the comforts of home may not be available.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly, and use may be made without departing from the principles and concepts set forth herein.

What is claimed is:

1. A personal, portable sanitary device for cleansing a user, comprising:
an attachment body comprising a first attachment site, a second attachment site, and a lumen formed through the attachment body to allow for fluid flow;
a first fastening assembly and a second fastening assembly for connecting to the first attachment site and the second attachment site, respectively;
a wand comprising a lumen to allow for fluid flow and an outlet to allow fluid to exit the wand;
a connecting member for connecting the attachment body to the wand, wherein the connecting member comprises a lumen to allow for fluid flow; and
a stopper that radially expands when compressed as said first fastening assembly is compressed with respect to said second fastening assembly, such that a seal is created with respect to an entry into a portable container, which is configured and arranged for storing fluid.

2. The personal, portable sanitary device of claim 1, wherein the lumen in the wand comprises a bend that is in communication with the outlet to direct the flow of fluid to a particular location and to create a turbulent flow of fluid, such that the fluid is sprayed when exiting said outlet.

3. The personal, portable sanitary device of claim 1, wherein the wand comprises a length that is within a range of about three inches to about eight inches, such that the wand is sufficiently long to locate the outlet of said wand with respect to a user and thereby direct the flow of fluid to the user's body and body cavities with limited user body movement.

4. The personal, portable sanitary device of claim 1, wherein the wand comprises a coupler at an end substantially opposite the outlet of said wand that is configured and dimensioned to couple the connecting member to the wand.

5. The personal, portable sanitary device of claim 4, wherein the connecting member is a flexible tubing that is attachable to the coupler of the wand via an interference fit.

6. The personal, portable sanitary device of claim 1, wherein the attachment body comprises a coupler at an end of said attachment body that is configured and dimensioned to couple the connecting member to the attachment body.

7. The personal, portable sanitary device of claim 1, wherein the stopper is compressible, such that it seals a plurality of opening sizes of the portable container.

8. The personal, portable sanitary device of claim 7, wherein the stopper is compressible, such that it seals an opening of the portable container, which opening is within a range of about 0.75 inches to about 1.25 inches.

9. The personal, portable sanitary device of claim 1, wherein the first attachment site of the attachment body comprises a first threaded section and a first unthreaded section and the second attachment site comprises a second threaded section, wherein the first attachment site is separated from the second attachment site by a substantially stationary flange.

10. The personal, portable sanitary device of claim 9, wherein the first fastening assembly comprises an expansion gasket having a lip that engages the stopper, thereby assisting the stopper in sealing the portable container; wherein the first fastening assembly further comprises a threaded nut for matingly engaging the first threaded section of the first attachment site; and wherein the second fastening assembly comprises at least one gasket and a threaded nut for matingly engaging the threaded section of the second attachment site thereby creating two different sealing sites for sealing different types of portable containers comprising fluid with one attachment body.

11. The personal, portable sanitary device of claim 10, wherein the first sealing site is a hard compression seal and the second attachment site is a soft compression seal.

12. A personal, portable sanitary system for cleansing a user, comprising:
a portable container for housing fluid;
an attachment body comprising a first attachment site, a second attachment site, and a lumen formed through the attachment body to allow for fluid flow;
a first fastening assembly and a second fastening assembly for connecting to the first attachment site and the second attachment site, respectively;
a wand comprising a lumen to allow for fluid flow and an outlet to allow fluid to exit the wand;
a connecting member for connecting the attachment body to the wand, wherein the connecting member comprises a lumen to allow for fluid flow; and
a stopper that radially expands when compressed as said first fastening assembly is compressed with respect to said second fastening assembly, such that a seal is created with respect to an entry into a portable container, which is configured and arranged for storing fluid.

13. The personal, portable sanitary system of claim 12, wherein the portable container is a bottle.

14. The personal, portable sanitary system of claim 12, wherein the portable container is a sealable plastic bag.

15. The personal, portable sanitary system of claim 12, wherein the lumen in the wand comprises a bend that is in communication with the outlet to direct the flow of fluid to a particular location and to create a turbulent flow of fluid, such that the fluid is sprayed when exiting said outlet.

16. The personal, portable sanitary system of claim 12, wherein the wand comprises a length that is within a range of about three inches to about eight inches, such that the wand is sufficiently long to locate the outlet of said wand with respect to a user and thereby direct the flow of fluid to the user's body and body cavities with limited user body movement.

17. The personal, portable sanitary system of claim 12, wherein the wand comprises a coupler at an end substantially opposite the outlet of said wand that is configured and dimensioned to couple the connecting member to the wand.

18. The personal, portable sanitary system of claim 17, wherein the connecting member is a flexible tubing that is attachable to the coupler of the wand via an interference fit.

19. The personal, portable sanitary system of claim 12, wherein the attachment body comprises a coupler at an end of said attachment body that is configured and dimensioned to couple the connecting member to the attachment body.

20. The personal, portable sanitary system of claim 12, wherein the stopper is compressible, such that it seals a plurality of opening sizes of the portable container.

21. The personal, portable sanitary system of claim 20, wherein the stopper is compressible, such that it seals an opening of the portable container, which opening is within a range of about 0.75 inches to about 1.25 inches.

22. The personal, portable sanitary system of claim 12, wherein the first attachment site of the attachment body comprises a first threaded section and a first unthreaded section and the second attachment site comprises a second threaded section, wherein the first attachment site is separated from the second attachment site by a substantially stationary flange.

23. The personal, portable sanitary system of claim 22, wherein the first fastening assembly comprises an expansion gasket having a lip that engages the stopper, thereby assisting the stopper in sealing the portable container; wherein the first fastening assembly further comprises a threaded nut for matingly engaging the first threaded section of the first attachment site; and wherein the second fastening assembly comprises at least one gasket and a threaded nut for matingly engaging the threaded section of the second attachment site thereby creating two different sealing sites for sealing different types of portable containers comprising fluid with one attachment body.

24. The personal, portable sanitary system of claim 23, wherein the first sealing site is a hard compression seal and the second attachment site is a soft compression seal.

25. A personal, portable sanitary system for cleansing a user, comprising:
a portable container for housing fluid comprising an opening therein;
an attachment body comprising a first modular portion, a second modular portion, and a lumen formed through each component of the attachment body, wherein each lumen is aligned when the first modular portion is attached to the second modular portion to allow for fluid flow through the entire attachment body;
a plurality of gaskets for substantially sealing the opening in the portable container;
a wand comprising a lumen to allow for fluid flow and an outlet to allow fluid to exit the wand; and
a connecting member for connecting the attachment body to the wand, wherein the connecting member comprises a lumen to allow for fluid flow;
wherein the first modular portion comprises one of a male connector and a female connector, and the second modular portion comprises the corresponding, opposite male connector or female connector, such that the male connector is insertable through the opening of the portable container and into the female connector to form a friction fit, such that when the first modular portion is assembled with the second modular portion a compression force is applied to the gaskets to substantially seal the opening of the portable container.

26. The personal, portable sanitary system of claim 25, wherein the portable container is a sealable plastic bag.

27. The personal, portable sanitary system of claim 25, wherein the lumen in the wand comprises a bend that is in communication with the outlet to direct the flow of fluid to a particular location and to create a turbulent flow of fluid, such that the fluid is sprayed when exiting said outlet.

28. The personal, portable sanitary system of claim 25, wherein the wand comprises a length that is within a range of about three inches to about eight inches, such that the wand is sufficiently long to locate the outlet of said wand with respect to a user and thereby direct the flow of fluid to the user's body and body cavities with limited user body movement.

29. The personal, portable sanitary system of claim 25, wherein the wand comprises a coupler at an end substantially opposite the outlet of said wand that is configured and dimensioned to couple the connecting member to the wand.

30. The personal, portable sanitary system of claim 29, wherein the connecting member is a flexible tubing that is attachable to the coupler of the wand via an interference fit.

31. The personal, portable sanitary system of claim 25, wherein the attachment body comprises a coupler at an end of said attachment body that is configured and dimensioned to couple the connecting member to the attachment body.

32. The personal, portable sanitary system of claim 25, wherein the second modular portion comprises the male connector and the first modular portion comprises the female connector.

33. The personal, portable sanitary system of claim 32, wherein the first modular portion comprises a first lip that engages one of the plurality of gaskets on the outside of the portable container, and wherein the second modular portion comprises a second lip that engages another one of the plurality of gaskets on the inside of the portable container, such that the male connector is insertable through one of the plurality of gaskets, through the opening of the portable container, through another one of the plurality of gaskets and into the female connector, thereby creating a soft compression seal to substantially seal the opening of the portable container.

34. The personal, portable sanitary system of claim 33, wherein the male connector is configured and dimensioned with respect to the female connector, such that said male connector does not bottom out in said female connector, and such that the first lip of the first modular portion and the second lip of the second modular portion substantially abut each other with the plurality of gaskets between them to create the soft compression seal.
